(19) United States
(12) Patent Application Publication
(10) Pub. No.: US 2014/0265347 A1
(43) Pub. Date: Sep. 18, 2014

(54) Universal cross hyperbaric, hybrid, thermal electric engine compressor, expander and universal mobility systems

(71) Applicant: Marius Angelo Paul, Yorba Linda, CA (US)

(72) Inventor: Marius Angelo Paul, Yorba Linda, CA (US)

(21) Appl. No.: 13/815,971

(22) Filed: Mar. 18, 2013

(51) Int. Cl. H02K 7/18

(52) U.S. Cl. CPC H02K 7/18
USPC 290/1 A

(57) ABSTRACT

The invention relates to the universal, and supreme cross hyperbaric, hybrid, direct transformation systems of any and all forms of thermal energies, directly in electric energy, based on the maximum absolute efficiency, of the thermodynamic, cross hyperbaric thermal electric engine, associated with all forms of operations and structures, including, general linear and rotary electric generators, integrating all the thermal energies, produced by the internal combustion engine, including the homogenous fuels combustion, activated by the super aero self-injection, and by the universal alternatively convertible engine in compressor, and expander, for braking energy hybrid recovery, including for total distributed energy production, by universal mobility systems.

The invention is the continuation in part of our earlier inventions with the titles:
1. Universal Energy and Mobility Systems
   Application No. 61/402,330
   Filling date: Aug. 28, 2010
2. Universal Thermal Electric Energy and Mobility Systems
   Application No.: 61/453,918

The invention relates to the universal, and supreme cross hyperbaric, hybrid, direct transformation systems of any and all forms of thermal energies, directly in electric energy, based on the maximum absolute efficiency, of the thermodynamic, cross hyperbaric thermal electric engine, associated with all forms of operations and structures, including, general linear and rotary electric generators, integrating all the thermal energies, produced by the internal combustion engine, including the homogenous fuels combustion, activated by the super aero self-injection, and by the universal alternatively convertible engine in compressor, and expander, for braking energy hybrid recovery, including for total distributed energy production, by universal mobility systems.

The invention is the universal and total integration of all forms of thermal energies, from any and all sources, internal, eternal, natural or created by other technologies, for direct transformation in electric energies, mechanically, pneumatically, for universal mobility, pure water, petrol, and coal shale recovery.

### BACKGROUND

The actual world crisis of energy, water, petrol, coal, environmental pollution, and transportation systems, is generally characterized, by low and extreme low efficiency to produce, extract, use, and protect the environmental of humanity.

The effective and most dramatic, evident, and terrible effect, is the example of the extreme low efficiency of majority of multimillion vehicles at the level of 15-20%, destroying 85% of the energy of the petroleum fuels, lost by, low thermal efficiency, cooling, exhaust gases, and high mechanical friction and complexity resulting of multibillion and trillion annual waste from all the universal mobility systems, including high emission of entire planet.

The recent trial of unsuccessful lithium batteries, for electric cars, is totally compromised by terrible aviation and electric vehicle explosions and self-combustion, closing any potential future for better more efficient transportation systems.

The entire civilized world is in a major dependency of fossil fuels, in special petrol which reached now enormous prices, and after the massive reduction of pressure in the wells, the petroleum production was dramatically diminished, and the petroleum recovery and production, dropped after 100 years, of extraction, from all the existing many of the mature wells.

Without natural pressure, and reduced liquidity, and having only high viscosity, high density shells of solid rocks, today in the world, are no more available efficient technologies for extraction.

These deposits still represent the biggest natural reserves of energy of humanity for eternity. Unfortunately the actual new very controversial hydraulic fracking technology of injecting the most valuable natural resources of water, and by underground contamination, including seismic potential calamity, is one of the biggest danger against the human life in the area of operation, with extreme opposition from affected population.

### BRIEF DESCRIPTION OF THE INVENTION

The invention of Cross Hyperbaric, Hybrid, Thermal Electric Engine, Compressor, Expander, and Universal Mobility Systems, is a revolutionary multiple solutions for solving all these, and many other problems, of actual conventional technologies, by the new fundamental and eternal technology of Cross Hyperbaric Engine, result of 30 years of development which achieved the top maximum absolute efficiency of 85%, producing including pure water, in all the history of internal combustion engines.

First, this cross hyperbaric, hybrid aero electric technology, by integrating, and recovering all the major loses, of cooling, exhaust, and eliminating the major source of mechanical frictions, is reducing all the loses by unproductive strokes of the four strokes engine cycles, and is making all engines with only two cylinders, and no more multi cylinder engines for any power and size.

This new cross hyperbaric hybrid, aero electric technology is for aero-electric recovery of braking energy, by absorbing this energy, and converting the engine in air compressor, storing the energy in high pressure air tanks, and is, recovering the energy for propulsion by transforming the engine in expander, driving with maximum efficiency hybrid propulsion and zero emission, all the vehicle, without the terrible lithium batteries.

The Cross hyperbaric, hybrid, Thermal Electric Engine, is the technology of integrating also, linear and rotary electric generators, transforming all the power strokes of thermal energies produced by the engine, directly in electric power, associated with double action air/oxygen-gas compressor, which is the general supporter, of the technology for petroleum-coal enhanced recovery and preliminary in situ partial refinery of petrol from the shalls, producing liquid petrol, and petrol synthetic gases and hydrogen generation, for combustion in the Cross Hyperbaric Engine power plant, on the surface, which is also the source of pure water cogeneration.

This new thermal electric engine is a supplier of electric energy, pure water and heat, without any mechanical shafts or transmission directly to the electric wheels of the vehicle, resulting a massive simplification of entire vehicle.

The capability of thermal electric cross hyperbaric engine, to be alternatively convertible in air compressor for absorbing and storing the braking energy and to return the energy by self-expander operation to the general efficiency of the vehicle, without electric expansive and dangerous lithium batteries, is the culmination of this miracle triple nature—engine-compressor-expander, new aero electric hybrid engine technology systems.

Our new aero electric technology, described above, can be extended to be applied to all existing and new engine of two and four cycle operation, which are using overhead intake and exhaust valves, receiving all the benefits resulted from all the features and characteristics described on above general new invention.

The elimination of cooling radiators, and super collecting the thermal energy from exhaust gases, resulting a virtually adiabatic engine, generating high pressure hot steam, which is available to make alternative Rankine cycles for power strokes, complimentary, alternatively and additional to the internal combustion power strokes, is converting completely, near entire thermal energy, in effective and maximum absolute electric energy.

Specifically the universally controlled homogenous total clean combustion of two/four cycle engines, capable to produce an enormous impact to the capacity to accept and use, unrestricted all the available fuel liquid or gases, CNG, LNG, LH2, LPG, ETHANOL, BIO-FUELS, NH3, single, and blended in any proportions, by the super aero self-injection and atomization to the level of molecular cracking, is an absolute revolution unique in the history of all kind of engines.

Over all the thermal aero electric cross hyperbaric engine is supplying the electric energy and pure water, in any places by plug out to the external users, making the vehicle a gold mine on wheels.

The chassis of all vehicles can be made from tubular bares, capable to be complete storage of compressed air for absorbing, and delivering the braking energy, resulting a new super-efficient vehicles with no extra cost, and a combined storage for all liquid fuel and gasses, for alternative operation, based on any sources of fuels available in the market.

The basic inherent combination of aero electric engine-compressor-expander, or gas aero electric turbine for compressing oxygen, and power electric expander, is generating the possibility to inject extreme high pressure of oxygen in the deepest bottom zones of petroleum wells, including in the high viscosity or even solid shalls of petrol, for underground partial combustion, enhanced petrol recovery, petrol gasses production including hydrogen, with zero emission, and eternal geothermal power generation, is offering to the world the top absolute energy eternal revolution.

### BRIEF DESCRIPTION OF THE DRAWINGS

FIG. 1: Represent the technology of the Universal Cross Hyperbaric Hybrid Thermal Electric Engine, Compressor, Expander, and Universal Mobility Systems, general concept.

FIG. 2: Represent the technology of Double Action of the Air-Gas Compressor.

FIG. 3: Represent the Technology of General Aero Electric Cross Hyperbaric Concept, of adiabatic engine, with total integration and recovery of all thermal loses, with the Universal Hyperbaric Self-injection and homogenous combustion chamber systems.

FIG. 4: Represent the same technology of General Aero Electric Cross Hyperbaric Concept, generically applied to all existing engines, and may be actual new engines.

FIG. 5: Representing the same technology of tubular chassis, and the technology for Universal Aero Electric Hybrid propulsion systems, by the compressed air storage hybrid systems.

FIG. 6: Represent the technology of Aero Electric trains of trailers.

FIG. 7: Represent the technology of Aero Electric enhanced petroleum recovery including from petroleum shales by self-injection of high pressure oxygen.

In the FIG. 1 is represented the technology and general concept, of the Universal Cross Hyperbaric, Hybrid, Thermal Electric Engine, Compressor, Expander, and Universal Mobility Systems, indicated generically by the number (10), composed from the two engine cylinders, 1, and 2, having pistons 3, and 4, connected with central cross bar 5, and perpendicular cross bar 6, articulated with the connecting rods 7, and 8, driving the counter rotating mono crankshafts, 9, and 10, associated by the counter rotating gears, 11, and 12, each cylinders are covered by the cylinder heads 13, and 14, having associated on the cross central bar 5 the linear permanent magnet inducer 15, sliding in the coil electric generator, 16, associated with the double acting air-gases compressor 17, compressing air/oxygen on firs side 18, and on top side general gases 19, controlled by the divert valve 20, connecting the gases high pressure storage tank 21, by the branch 24, and by the optional branch air/oxygen, by the bottom side of the compressor 17. The air/oxygen flow is controlled by the diverter valve 25, and 26, connected with the air/oxygen storage tank 27, and relief valve 28.

The rotary electric generators are delivering the electric energy by the electric branches 29, and the linear electric generators are delivering the alternative current 30, and 31, the separated nitrogen is eliminated by escape exit 32. All the electronic control ECM, is driven by one of crankshaft 9-11, supplying and supervising all the sequential operation of the thermal cross engine, in relation with power generation, compressing air for braking, and the air expander of the hybrid recovery system.

The very important function of the compressed oxygen at very high pressure, is for injecting oxygen on the bottom of the petroleum wells, shells for starting a partial combustion of the petrol by creating local balls of melted, vaporized and preliminary cracked by combusted petrol, generating CO, CO2, and Hydrogen, and pure water.

All of them are reducing the viscosity of the petroleum composition, result of partial refinery process, producing pre-refined high quality petrol elevated over the petrol wells, by the pressure of generated gases, and by the bottom of condensed pure water.

The Hydrogen generated in the wells, will be burned out by the Cross Hyperbaric Thermal Electric Engine on the surface power plant, producing energy and pure water, and capturing the CO2, in green garden for tropical equivalent garden for production of all vegetable and algae bio fuel coproduction, day and night, 365 day per year and generating the oxygen, for recycling the eternal process, a final miracle for salvation the humanity.

In the FIG. 2 is indicated the double acting air/oxygen and general gases compressor (20), connected and associated by the central cross bar 5, the general compressor gases cylinder 37, and the air/oxygen cylinder 36, 38, having the intake port of general gases 39, and the connection internal channel 40 to the exit pipe 41, supplying the compressed general gases by the exhaust ports 42, when the piston 35, finished the compression stroke, with coincident pipe port 41, with the exit port 42.

By the reciprocator opposed cylinder-piston 36 situated in the bottom dead center of finished compression stroke 47, the connection channel 46 is delivering the compressed air/oxygen through the exhaust port 47. In the tanks 21 and 27 (indicated in FIG. 1).

In the FIG. 3 is indicated the technology of General Aero Electric Cross Hyperbaric concept with universal Hyperbaric, adiabatic engine system, integrating and recovering all cooling and exhaust thermally loses, with the possibility to operate alternatively with combustion power cycles and recovery Rankin steam power cycles, using optional liquid fuels aero self-injection systems, and alternatively operation of any and all natural gas or all gases, in the same homogenous combustion chamber, including with the assistance of the compressed air storage for hybrid air operation.

The FIG. 3 is generically indicated the by generic number (30), composed for three sub FIGS. 30A, 30B, 30C.

In the sub FIG. 30A, is indicated the engine cylinder 50, provided with the piston 51, situated in the bottom dead center, controlling the intake ports 53, having the exhaust valve 54, the piston is provided with piston rings 52, 55, 57, and the circular channel 58.

The cylinder is covered by the cylinder head 59, and connected with the external homogenous combustion chamber 60.

The engine cylinder is cooling by high pressure pure water, supplied by pump 72, injected in the cylinder cooling jacket 56, and is transferred in the cylinder head 59, and collected from the cylinder head by exit port 73, and conducted in the heat exchanger 74, to receive the thermal energy from exhaust gases 75, and to be transformed in high pressure, high temperature steam 76, and controlled by the electronic hydraulic valve 77, injecting the steam in the combustion chamber 60, in the alternative operation of Rankine power stroke cycle.

The combined thermal cross hyperbaric combustion power stroke, followed by the Rankin steam power stroke, is creating the top absolute thermodynamic cycle of Paul-Rankin-Carnot Cycle with maximum absolute 100% integrating all the thermal energies, generated by the cross hyperbaric engine, defining this technology the total absolute adiabatic thermodynamic cycle, which reached the end of the thermodynamic evolution by this total thermodynamic revolution, for eternity.

In the sub FIG. 30B, piston 52 is situated in the top dead center, at the end of the compression stroke, and starting the combustion process, by the aero self-injection the compressed air from top combustion chamber 61, through the communication channel 62, and the ports 63, is injected in the external homogenous combustion chamber 60, and by exit port 64, and by the conduit 65, the high pressure air, is controlled by the one way automatic valve 66, is injecting the fuel supplied by the one way controlled valve 67, with the atomizer injector 68, in the external homogenous combustion chamber 60, is provided with the glow plug 69.

The super high pressure air self-injection 68, is producing the most effective perfect fuel atomization, in the external homogenous combustion chamber 60, in conjunction with high pressure air injected from the piston channels 62, 63, 64, generating an extremely high turbulence of the combined mixture of double air injection in the residual plasma gas periodically captured from cycle to cycle.

By the periodically retaining the captured hot partially expanded combustion gases, is automatically obtaining a homogenous captured plasma combustion gases, which is eliminating the violent diesel ignition of injected fuels resulting a very smooth combustion totally without the diesel knock, or the detonation specific of spark ignition engines, at high compression ratios.

The most important result is the capability to use unlimited compression and top combustion pressure conducting to maximum absolute efficiency demonstrated over 85%. The result is the top absolute and perfect combustion process in the history of internal combustion engines.

The continuous residual hot plasma, providing to each new injected fuel the condition of cycle to cycle 360 degree residence time, for super vaporization and cracking all the hydrocarbon fuels to the last <<<one carbon>>> methane molecular status, is producing an equivalent new refinery process, and conducting to a perfect combustion process.

In the FIG. 30C, is indicated the controlled three way valve 70, which is making the first communication with the compressed air storage tank 71, in which is accumulated the braking energy, produced by the alternatively conversion of the engine, in air compressor, and stopped fuel injection, with no combustion, followed, at starting the engine to be converted in expander, returning the braking hybrid energy to the vehicle, for maximization of the total efficiency.

The cross hyperbaric, hybrid aero electric engine, can be optional operated with CNG, or any alternative gas fuels including hydrogen by connection the external homogenous combustion chamber 60, with the alternative high pressure storage of gases 78, controlled by the diverting valve 70, making the engine an universal fuel combustion engine.

In the FIG. 4, is indicated the technology of General Aero Electric Cross Hyperbaric, concept, generically to potential application of existing engine and possible to actual production in market.

In this figure is indicated by the generically number (95), having indicated the top cross section of the cylinder head 96, provided with intake valves 97, and exhaust valves 98, the electromagnetic hydraulic primary valve 99, controlling the communication of the cylinder volume with the internal combustion chamber 80 provided with the glow plug 81, and the top electromagnetic valve 82, controlling the top communication channel 83, and final diverting valve 84, controlling the communication with the compressed air storage tank 85, and alternatively with all natural gas tank 100, storage of CNG, LNG, LPG, LH2, offering to this engine technology the universal capability to use all the available fuels, in the world, and the qualification the UNIVERSAL ENGINE OF THE WORLD.

For liquid fuels operations, the cylinder 96 is connected with the relief conduit of compressed air 86, and by the one way aero valve 87, and, fuel supplying one way valve 88, filling with a specific quantity of fuel accumulated in the conduit 89, for injecting he aero self-fuel by the injector 90.

The air separator of oxygen 92, is eliminating the nitrogen 93, and supplying the oxygen by the conduit 94, and the electronic control module 101, which is the general coordinator, of entire system, in accord with the electronic encoder 102, driven by the crankshaft 103. The oxygen is conducted in the intake valves 97, and the exhaust valve 98 is eliminating the final exhaust gases. The exhaust gases delivered by the exhaust valve 98 are conducted by the pipe 104, in the heat exchanger 105, transferring the heat to the water exist channel 106, heating the water to the level of steam with high temperature and pressure, which will be conducted by pipe 107, in the channel 108, from which will be injected in the engine combustion chamber by the diverter valve 84, creating an alternative operating Rankin steam power expansion stroke, complimentary with the internal combustion power stroke.

The alternative combined combustion power stroke and Rankin steam power stroke, is forming an unique total integrated thermal electric engine with absolute entire thermal energy of the cross hyperbaric, hybrid engine, transformed in electric energy, eliminating all the thermal loses of the cooling system, and recovering all the exhaust thermal energy, resulting an virtual 100% adiabatic thermal engine systems, achieving the maximum absolute thermodynamic efficiency with the definition of Paul-Rankine-Carnot Cycle, making the end of evolution, transformed in the absolute revolution, in all the history of eternal engines. The exhaust cooled gases closed to the condensing temperature of water is producing a by-product of pure water cogeneration.

By the use of oxygen without 80% Nitrogen in the composition of the air, the energetic capacity of the engine is multiplied by 500% and total elimination of NOX, WHICH IS THE WORKS POLLUTANT. The oxygen intake at atmospheric pressure is equivalent of supercharging of 5/1 conventional air turbo charging. The invention of the cross hyperbaric thermal electric engine technology which is eliminating the side force between piston and cylinder lines, is opening the demonstrated capacity to work at 300 kg/cm2, of compression and combustion, result of an supercharging at 10/1 turbo charging extraordinary unique maximum absolute energy capacity.

The system is working in three modes:

MODE 1 is <<<engine>>>, compressing air to the maximum pressure at the end of compressing stroke, supplying a jet of compressed air by the channel 86 crossing the one way valve 87, and receiving the fuel from the one way valve 88, will mixed the high pressure air with the fuel, forcing a self aero atomization of the injected fuel by the injector 90 in the combustion chamber 80, the liquid fuel is supplied by the service low pressure pump 109.

After the combustion is started, the electro hydraulic valve 99 is opening the communication with the cylinder which is, in the first phase, injecting the main quantity of 50% air in the combustion chamber 80, producing the big combustion pressure of the first combustion, which is reversing the combusted gases in the cylinder main combustion chamber in which the rest of 50% air is finishing the combustions, starting the expansion power stroke.

After near 60% of the power stroke is accomplished, the electromagnetic valve 99 is closing the communication with the cylinder volume, with the combustion chamber 80 capturing a partial expanded hot gases, to create the hot medium for homogenous mixture with the next fuel injection and the next cycle for continuous homogenous operation.

For operation with all kind of gases the separated high pressure tank 100 is storing CNG, LNG, LPG, LH2 and is connected to the engine combustion chambers 80 by the diverter valve 84, offering the universal absolute fuel capability, defining the universal engine of the world.

MODE 2 is <<<compressor>>>, starting by the command of braking, will stop the fuel combustion commanded by the electronic control module 101, in cooperation with encoder 102, driven by the crankshaft 103, the compressed air is stored in the tank 85, accumulating all the braking energy, for the air hybrid operation, is completing all the universal air hybrid capabilities, controlled by the diverter valve 84, when is a opening both electromagnetic valve, 99, and 82 the communication of the exit of the compressed air through the diverter valve 84, and filling the storage tank 85 with compressed air accumulating the braking energy, and at the end of the compressing stroke, both valves 99, and 82 are closing the communication; with the cylinder which is starting the air intake stroke for the next compressing stroke. By continuous air compressing, the braking energy, will stop the car.

MODE 3 is <<<expander>>>, starting the communication of the cylinder by opening both valves 99, and 82, in phase with the expansion stroke producing the return energy produced by braking, followed by air exhaust, and repeating the expansion energy production, offering to the vehicle a free driving proportional with the accumulated air energy stored in the tank 85.

This unique triple operation modes, is making this invention and the aero universal engine, the top absolute of the work culmination of all thermal engines forever.

In the FIG. 5, is indicated by the generic number (120) the technology of tubular chassis, and universal aero electric hybrid propulsion systems for general storage of energy by compressed air, primary for recovery of the braking energy, and released by expansion in special in urban areas for zero emission. The aero electric vehicle is framed on a tubular structure chassis divided on sectional individual storages, for compressed Air, Oxygen, Hydrogen, CH2, LH2, natural gas, CNG, LNG, LPG, Ethanol, NH3, and for all generally available fuels capable to be used by our universal cross hyperbaric thermal electric engine-compressor-expander, creating for the first time in the history of transportation industry an UNIVERSAL ETERNAL ABSOLUTE ENERGY AND MOBILITY SYSTEMS.

In FIG. 5 is depicted the tubular frame of the multiple storage of energy and all available fuels, indicated by the generic number (120), composed from the general tubular frame 121, integrating sectional reservoirs 122, 123, 124, 125, associated with the propulsion driving train on wheels 126 driven by electric motor-generators 127, and finally including also the gasoline or diesel fuels 128.

In the FIG. 6 is indicated the technology of aero electric trains of trailers, indicated by the generically number (130), having the composition of the front vehicle 131, with articulated connection 132, with the trailer vehicle 133, provided with the power energy module 134, described in the FIG. 1, and FIG. 2, and FIG. 3, of aero electric cross hyperbaric thermal electric power generator, and the triple modes of operation like engine-compressor-expander, performing all the functions, of the mobile power plant, hybrid universal vehicle, with the totality of capability, for sustaining the entire economic worldwide operation.

The electric power generation is supplied to all the electric driving wheels, by the electric cable 135, 136, 137 to the front vehicle, and of the trailer, for 100% thermal electric motorization and self-propulsion <<<no traction>>> only self-propulsion of entire train. And entire train is participating in the hybrid propulsion by aero electric recovery of braking energy provided with the energy storage of compressed air 138 and expander energy recovery of the air hybrid general systems.

The general utilization of the train like mobile power plant, distributed power systems and universal transportation is the biggest and unique, technology world revolution.

In the FIG. 7, is indicated the technology for geothermal and enhanced petroleum recovery from any petroleum wells, including from the deepest shales rock bottom deposits, indicated by the generic number (140), composed from underground petroleum well (141), in which is supplied by the air/oxygen/nitrogen separator 142, only oxygen 143, and eliminate nitrogen 144, and by the oxygen high pressure compressor 145, will be injected the oxygen in the tubular geothermal heat exchanger 146, in which oxygen will be distributed and heated, by double action one, in the ground petroleum partial combustion in wells, 148, and the second part of the heated oxygen will come to the surface to support the combustion in the external homogenous combustion chamber 149, of the cross hyperbaric engine, 140, and or the gas turbine alternative power generation systems.

The electric generator 150, will produce all the energy of the external surface power plant, which is supplied with general petroleum gases, including hydrogen, 151, 152, and 154. The liquid petrol will be separated and delivered by pipe 153. On the bottom of the well, and underground shall, 155 will be deposited the pure water generated by the combustion of hydrogen.

By underground controlled partial combustion, will be produced successively CO, CO2, PURE STEAM-WATER, PETROLEUM GASES, AND HYDROGEN, in the combustion regional ball 148, of fracking by high pressure gases.

All of these high pressure gases, will generate heat, liquefying the petrol, vaporize, and preliminary generating an underground refinery producing liquid petroleum 153, which will be pushed on the surface. All this underground technology, will restore the original petroleum pressure and producing a total enhance 100% petroleum recovery. The petrol production on the surface 155 is the biggest energy revolution until the total recovery to the last molecule of the existing petrol in the ground of humanity.

The petroleum gases 148 also heated with additional geothermal energy, loaded with high hydrogen composition, will be burned on the aero electric cross power plant 140, to produce electric energy by the generic electric energy generator 150, generating also pure water and eternal business until the end of the world, with zero emission.

Even after the extraction the last molecule of petrol and gases, the power plant still be supplied by geothermal energy, heating of the oxygen, and supporting the eternal power generation with zero emission, and not water contamination. The eternal future life and energy generation of humanity is guaranteed.

What is claimed:

1) This is the eternal and universal technology, for the universal direct transformation, of any and all forms of thermal energies, of internal and external sources, natural, eternal, nuclear, solar, wind, hydraulic, gravitational, geothermal, from fossil fuels, and synthetic, or created by other energy systems, directly in electric energy, mechanical energies, pneumatic energies, by the cross hyperbaric aero electric, thermal electric engine, having integrated, a thermal engine group of two thermal linear power cylinders, composed from groups of two cylinders engine, having each first piston interconnected with other symmetric piston, of each thermal linear power cylinder, by an axial interconnected, central cross axis bar, having integrated the linear electric power generator, composed from a permanent magnet mobile inducer, moving in the electric coil power generator, and the same both symmetric, linear thermal power cylinders are interconnected by symmetric cross bar, having perpendicular symmetric arm, driving by symmetric two opposed connecting rods, two counter rotating crankshafts, connected with rotary electric generators, and associated by the same cross axis, the coaxial double actions compressor, forming an absolute integrated, combined thermal-aero-electric systems, with continuous thermal aero and electric power generation by all power strokes of engine, and not absolute unproductive strokes, associated with all forms of operation and structures, including the universal homogenous combustion systems, activated and provided with the super aero fuel self-injection systems, including the universal cross hyperbaric alternatively convertibility and capability of multiple engine operation for convertibility of engine to air compressor and expander, for realizing a complete aero electric continuous hybrid systems, for total recovery of stored braking energy, and total recovery and integration of all thermal energies from cooling systems and exhaust gases, generating high pressure and temperature steam for alternative generating, successive power strokes of alternative Rankin cycles, for any and all land vehicles, including the capability to be an universal power mobility systems, forming a total and absolute complete thermal integrated systems of energies, and alternative unlimited thermal electric engine, for energy supplier, and for total wells and shalls, eternal geothermal energy production and petroleum recovery, in association with a universal electric mobility systems and distributed power systems, for outside users, stationary and or mobile.

2) This is the technology of the universal cross hyperbaric, aero electric thermal electric linear and rotary energy generator, from claim one, to be a universal systems, with unlimited flexibility and convertibility for optional alternative action like thermal engine linear and rotary electric generator, air compressor, and air expander operation, forming an universal aero electric hybrid systems, for total recovery of braking energy and all thermal cooling and exhaust loses, having an integrated alternative cooperation of successive steam Rankin power cycles for enhanced the efficiency of the vehicle propulsion, and the creation of the general and universal mobility systems, with thermal aero electric vehicles, and forming mobile distributed power and pure water systems, by self-energy electric generation, by and all categories of land vehicles, trains of trailers, railways and floating vehicles.

3) This is the technology, of the universal cross hyperbaric, aero electric engines, of claim one, and two, to be the universal eternal thermal electric engine systems, with universal fuel flexibility and combustion capability, activated by the super high pressure compressed air delivered from cylinder engine at the end of the compression stroke producing a self aero electric injection systems, of super atomization of any liquid fuels in the hot plasma of mixed hot retained combustion and partial expanded gases, retained from cycle by cycle and created by the universal technology of homogenous combustion chamber, of continuous combustion, capable to use individually, or combined, any fuels by having the capability of using unlimited kind of fuels with unrestricted proportion, forming universal engine, without any restriction from specific relation with the fuels characteristics.

4) This is the technology, of universal cross hyperbaric aero electric, thermal electric generator, from claim one, and two, integrated and provided with coaxial double action compressor, provided with double sided compressor piston, and double symmetric compression working volumes with alternative action compressor for high pressure compression for universal of any and all gases in one side of the compressor and separated supercharging of air/oxygen by opposed side, controlled and provided by integrated internal piston having communication channels, on the both working compressor volumes which are provided with intake ports, and exhaust ports, without any kind of valves, in which the double sided piston, is the unique and the general distributor and universal controller of the compression process, from intake t the end of compression and supplying all the gases and the air/oxygen by self-connection internal channels, controlling the intake and compression process, supplying the high pressure to the exit ports of separated air and general gases users.

5) This is the technology, of universal cross hyperbaric aero electric operation of engines having uni-flow intake ports and overhead exhaust valves, from claim one, three and four, provided with liquid fuel self aero high pressure injection systems, providing the high pressure aero jet for injection from the cylinder head top connection with the compression and combustion chamber, first in the external homogenous combustion chamber, and second main air injected in the external homogenous chamber, operated by self-controlled pistons, provided with internal channels for controlling the main air injection, by connecting the top internal compression-combustion chamber with the external combustion homogenous chamber, producing the main combustion and after near 60% expansion stroke to cut the connection of the both chamber, retaining a partial expanded hot gases for creating the next homogenous plasma for continuous homogenous combustion, and to continue the rest of complete expansion of the power stroke, by the diverting connection three way valve, will give the optional operation by alternative homogenous combustion with alternative fuels, of gases, CNG, LNG, LH2, LPG, PROPANE, BUTANE, or by any high pressure stored gases, and finally with compressed stored air for hybrid operation system, of recovery of braking energy systems, over all the engine cylinders are provided with high pressure water cooling systems, and controlling the temperature of the cylinder liner and the top cylinder head, by supplying high pressure water to an external heat exchanger, receiving heat from exhaust hot gases, resulting the generation of high pressure steam available to create an alternative power steam strokes expansion Rankin cycle, in association with thermal combustion cycles, the final result is the complete recovery of cooling energy and the residual energy of exhaust gases, producing a total energy maximum absolute efficiency thermal electric aero engine systems.

6) This is the technology, of universal cross aero electric thermal, electric, hyperbaric, hybrid energy systems, of claim one, applied by engines with multiple overhead valves, of two and four operation cycles, with universal controlled homogenous total clean combustion of universal fuel capability, and multiple modes of operation, with unlimited turbocharging, electro hydraulically controlled operation cycles, provided with two electronically hydraulic separable combustion chamber, one located in the cylinder head, provided with aero self high pressure aero liquid fuel injection system, having first mode of operation, and second main combustion chamber situated on the top cylinder working volume, separated by electro hydraulic valve for controlled communication between main combustion cylinder working volume and the homogenous separated combustions chamber, producing first combustion in the homogenous combustion chamber and when the communication is established between the combustion chambers, the main compressed air is injected in the homogenous combustion producing the big combustion process of at least 50% of the fuel and air is accomplished, resulting a big pre combusted gases to by transferred in the main combustion chamber in the cylinder for final 100% combustion, and starting the expansion stroke, which after reaching near 60% expansion the combustion chambers are separated by the electro hydraulic main valve, and the rest of expansion will be finished only in the cylinder working volume. The second mode of operation, is starting with the separated homogenous combustion chamber is supplied by CNG, or other high pressure gases, by open communication of the top electro hydraulically controlled valve with the source of gases, for limiting the quantity of gases introduced in the homogenous combustion chamber, and after the communication with outside gases is stopped, the communication with the cylinder main chamber is producing the main compressed air injection, and combustion and expansion is finished, finished with again separation of combustion chambers, both combustion mode of operation are supplied by oxygen air separated from nitrogen, for maximizing 500% the energy and the capacity of the engine combustion without NOX pollution. The third mode of operation is the complete collection of the cooling energy by high pressure water steam generation and superheating the steam in the high pressure heat exchanger, with the exhaust gases residual thermal energy, by injecting the steam in the connect both chambers with open complete connection of the top and main electro hydraulically controlled valves, in communication with the cylinder working volume controlled power expansion, producing an associated alternative steam working stroke of Rankine power alternative associated recovery cycle with the combustion power cycle, resulting the absolute total energy world engine with maximum absolute efficiency.

7) This is the technology of the universal cross hyperbaric aero electric, thermal electric generator, of claim one, with double action high pressure coaxial compressor, from claim one, and three, which is the enhance technology for ultimate recovery of any petrol from any wells, including by oxygen injection fracking, and supplying of high pressure oxygen and CO2, in the deep petroleum wells, and shells, for underground restoring the wells pressures, by partial deep combustion, for self-underground production of CO, CO2, pure water-steam, for vaporization, fluidization of petrol, and gases including hydrogen, to be supplying all the petroleum generated products on the surface, for eternal associated power aero electric oxygen generation and pure water, by a continuous closed cycle of cooperation of the surface power generation, and the enhanced top absolute petrol recovery process, in cooperation with the recovery of all geothermal energy from the power production.

8) This is the technology of the universal cross hyperbaric aero electric, thermal electric generators, associated with a general new vehicle structure formed from tubular, chassis, forming aero electric, and universal fuels and gases mobile storage systems, for transporting and storing the energy of compressed air resulted from the braking energy, and aero electric hybrid propulsion, and storage of alternative fuel gases at high pressure CNG, LNG, LH2, bio-fuels, ethanol, NH3, or general and specific energy storage, for zero emission vehicle, and universal distributed mobile power generation.

9) This is the eternal cross hyperbaric hybrid thermal aero electric energy geothermal energy systems, which will continue to operate eternally even after all petroleum reserves will be exhausted, based on compressing air or oxygen on the deep end of tubular heat exchanger, for extraction of eternal geothermal energy, to the surface cross hyperbaric aero electric power generator with zero emission, and zero water contamination.
